(19) United States
(12) Patent Application Publication
(10) Pub. No.: US 2009/0045029 A1
(43) Pub. Date: Feb. 19, 2009

(54) CONVEYOR ROLLER AND CARTRIDGE BEARING ASSEMBLY FOR SAME

(76) Inventor: Delwyn G. Deur, Grand Rapids, MI (US)

Correspondence Address: COOK ALEX LTD, SUITE 2850, 200 WEST ADAMS STREET, CHICAGO, IL, 60606, US

(21) Appl. No.: 12/186,909

(22) Filed: Aug. 6, 2008

Related U.S. Application Data
(60) Provisional application No. 60/956,147, filed on Aug. 16, 2007.

(51) Int. Cl. B65G 13/00

(52) U.S. Cl. 193/37

(57) ABSTRACT

A conveyor roller assembly adapted to be received between opposed side walls in a conveyor frame is provided including a cylindrical tube and an insert adapted to be received in each of the open ends of the cylindrical tube. Each insert includes a stub shaft having a free end that extends from the insert beyond the end of the tube when the insert is received therein, the stub shaft being rotationally-fixed relative to the insert so as to be rotatable with the cylindrical tube. A bearing housing is secured to each insert, each bearing housing including at least one bearing adapted to receive the stub shaft so as to permit relative rotational movement between the bearing housing and the insert. The bearing housing is adapted to be supported by the sidewall of the conveyor frame so as to prevent relative rotational movement between the bearing housing and the sidewall.

### CROSS REFERENCE TO RELATED APPLICATION

This application claims the benefit of the filing date of U.S. Provisional Application Ser. No. 60/956,147, filed Aug. 16, 2007, the entire contents of which is herein incorporated by reference.

### BACKGROUND

The subject matter of the present disclosure relates to a conveyor roller, and more particularly, to a conveyor roller having cartridge bearing assemblies including a stub shaft.

It is known to provide a conveyor roller in which the roller comprises a hollow, cylindrical tube having a bearing housing mounted within each end into which a stub shaft is journaled to permit relative rotation between the roller tubing and the stub shaft axial. See, U.S. Pat. No. 3,353,644 to McNash et al. and U.S. Pat. No. 4,606,659 to Hogan. These patents are typical of such designs in that the stub shaft axles are held stationary between the opposed sidewalls of the conveyor frame, with the roller cylinder being able to rotate about the stationary stub shaft axles.

### SUMMARY OF THE INVENTION

The cartridge bearing assembly disclosed herein constitutes a departure from the typical conveyor roller and bearing assemblies in that the stub shaft axles are fixed so that they rotate in unison with the roller tubing. Further, the bearing housings are mounted externally of the roller tubing on the stub shafts and are adapted to be secured to the conveyor sidewalls.

More, specifically, a conveyor roller assembly is provided that is adapted to be received between the opposed sidewalls of a conveyor frame. The assembly includes cylindrical tube with opposed open ends. A cartridge bearing assembly is provided that is adapted to be received in each of the open ends of the cylindrical tube. Each assembly or insert includes a stub shaft axle having a free end that extends from the insert beyond the end of the tube when the insert is received in the tube. The stub shaft is rotationally fixed relative to the insert so as to be rotatable in unison with the cylindrical tube. A bearing housing including at least one bearing is provided for each insert, with the bearing housing adapted to receive the stub shaft axle so as to permit relative rotational movement between the bearing housing and the roller tube. The bearing housing secured to the stub shaft and is configured so that it is supported by the sidewall of the conveyor frame so as to prevent relative rotational movement between the bearing housing and the sidewall.

Preferably, the stub shaft axle of at least one of the inserts is axially moveable relative to the insert. This axially-moveable stub shaft is also preferably biased outwardly of the cylindrical tube. Such an axially-moveable stub shaft facilitates installation and replacement of the conveyor roller.

### BRIEF DESCRIPTION OF THE DRAWINGS

FIG. 1 is an exploded perspective view of a first embodiment of a conveyor roller and associated cartridge bearing assemblies.

FIG. 2 is a cross-sectional view of an assembled conveyor roller and associated cartridge bearing assemblies according to the first embodiment.

FIG. 3 is a side view of an axially-movable stub shaft forming a portion of an axially movable roller insert.

FIG. 4 is an end view of a cup member forming a portion of an axially movable roller insert.

FIG. 5 is a side view of a bearing housing or retainer to be received on the stub shafts of the roller inserts.

FIG. 6 is an end view of a roller insert in which the stub shaft is axially fixed.

FIG. 7 is an exploded perspective view of a second embodiment of a conveyor roller and associated cartridge bearing assemblies.

FIG. 8 is a cross-sectional view of an assembled conveyor roller and associated cartridge bearing assemblies according to the second embodiment.

### DETAILED DESCRIPTION

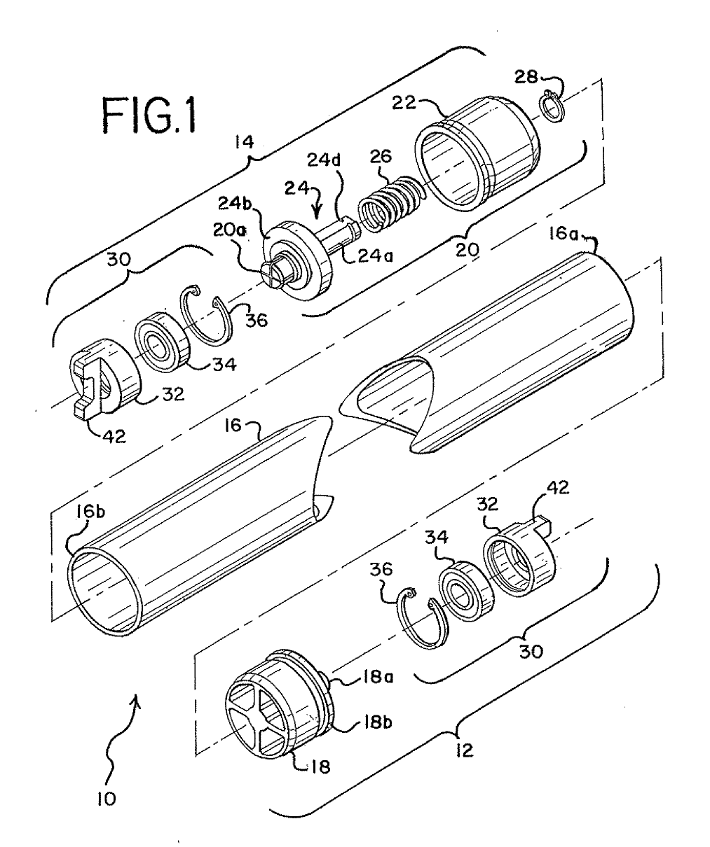

Turning to FIG. 1, there is seen exploded perspective view of a conveyor roller assembly, generally designed 10, with cartridge bearing subassemblies generally designed 12 and 14, in accordance with the present disclosure. In contrast to the prior art, the conveyor roller assembly 10 described herein includes inserts with stub shaft axles that are received in the ends of the roller tube so that the stub shaft axles are fixed rotationally relative to the roller cylinder. The bearing assemblies, instead of being located interior of the roller tube, are supported on their respective stub shaft axles. Thus, when assembled between the sidewalls of the conveyor frame, the bearing housings are held stationary, while the conveyor roller tubing and inserts/stub shafts rotate in unison.

With reference to FIG. 1 the roller assembly 10 includes a hollow cylindrical tubing member 16 with opposed open ends 16a and 16b. The tubing member 16 is typically made of steel and, in the preferred embodiment, has a nominal outside diameter of 1.9 inches, although other diameters may be used without departing from the invention. The tubing is preferably 16 gauge flow coated steel, although other materials may be used. Inserts 18, 20, each having a rotationally-fixed stub shaft axle 18a, 20a extending therefrom, are received in the open ends 16a, 16b of the roller tubing 16.

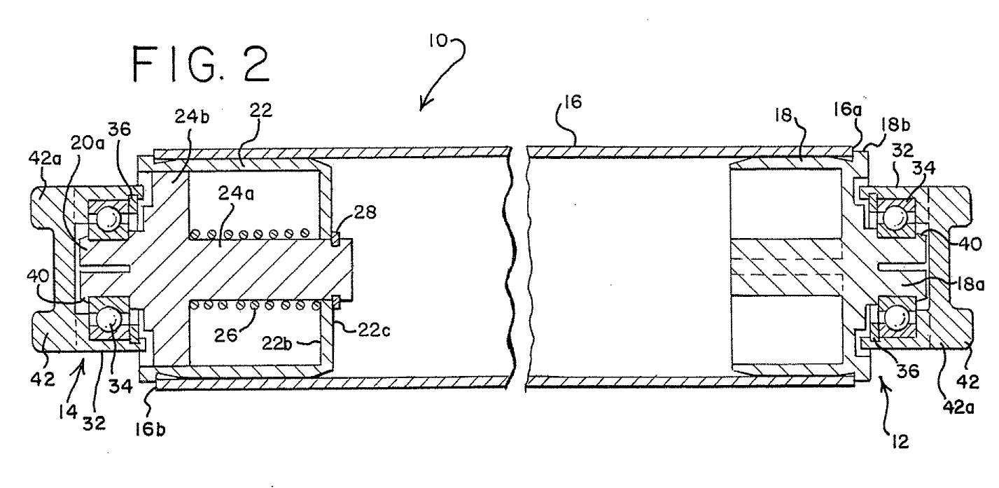

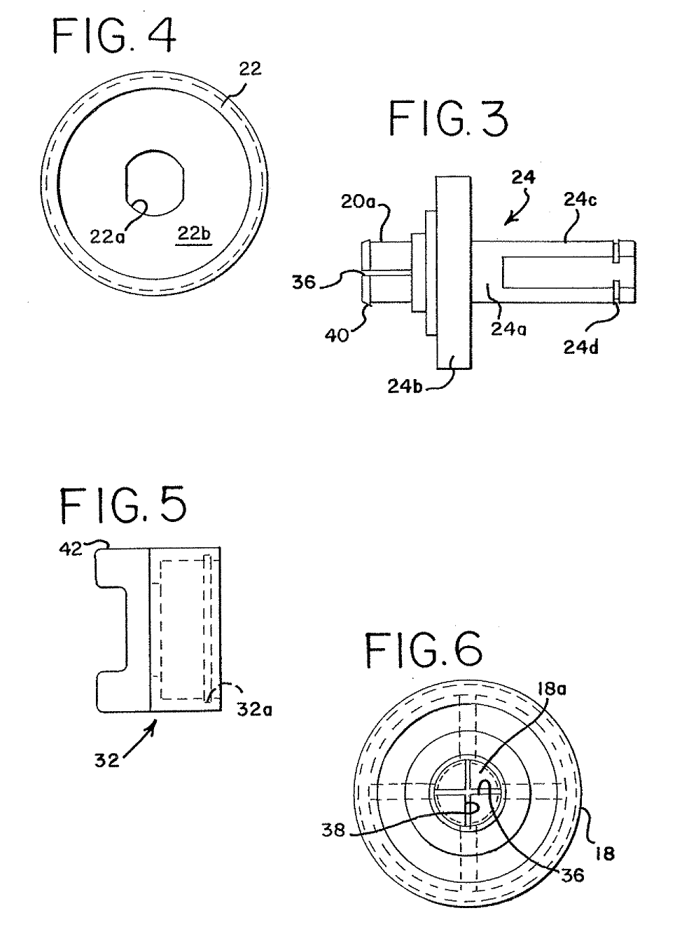

In the first insert 18, the stub shaft 18a (best seen in FIG. 2) is axially fixed relative to the insert. The insert 18 is configured so that the stub shaft 18a extends beyond the end of the tube 17 when the insert 18 is received therein. The insert 18 includes an enlarged radial shoulder 18b that abuts the end 16a of the roller tube 16 to limit the inward position of the insert 18.

In the second insert 20, the stub shaft 20a is axially moveable to facilitate installation and replacement of an assembled roller between the sidewalls of a conveyor frame. Specifically, the insert 20 comprises a cup-shaped insert 22 that slidably receives the axially-moveable stub shaft or inner tube insert 24 therein. The insert 24 comprises an elongated shaft 24a with an enlarged collar 24b adapted to radially locate the shaft 24a within the cup-shaped tube insert 22 and to permit the shaft 24a to slide axially while the collar 24b remains within the confines of the tube insert 22.

Cup insert 22 also includes a non-circular aperture 22a (best seen in FIG. 4) which receives the inner end 24c of the shaft 24a. The inner end 24c of the shaft has a cross-sectional shape corresponding to the shape of the aperture 22a in the cup insert 7. The non-circular shape for the aperture 22a and the inner end 24c of the shaft 24a prevent relative rotation between the shaft and the insert, and consequently between the stub shaft 20a and the roller tubing 16. As illustrated, the cross-section of the inner end of the shaft 24c and the aperture 22a are oblong-shaped, with arcuate ends and parallel sides, although other non-circular shapes may be employed.

To bias the stub shaft 24 outwardly from the cup insert 22, a spring 26 is received on the inner end 24c of the shaft 24a and abuts the collar 24b on the insert 24 and the inner face 22b of the bottom of the cup insert 22. To limit the travel of the tube insert 24 outwardly from the insert 22, the inner end 24c of the shaft 24a includes a stop that abuts the outer face 22c of the bottom of the tube insert 22, thus limiting the outward movement of the stub shaft insert 24 relative to tube insert 22. As illustrated, the stop comprises a rotor clip 28 received in a groove 24d on the inner end 24c of the shaft 24a, although other forms of stops may be provided.

Each of the stub shafts 18a, 20a on the inserts 18, 20 has a bearing assembly 30 associated therewith. Each bearing assembly 30 includes a bearing housing or retainer 32 that receives a precision bearing 34. As illustrated, the precision bearing 34 is maintained in the retainer 32 by means of a rotor clip 36 received in an annular groove 32a in the housing 32 (best seen in FIGS. 2 and 5), although other techniques for securing the bearing 34 in the housing 32 are contemplated.

In order to facilitate the attachment of the bearing assemblies 30 to their respective stub shafts, the free ends of the stub shafts 18a and 20a are preferably radially compressible to a size so as to fit within the open interior of the bearing 34. As best seen in FIGS. 4 and 6, each stub shaft 18a, 20a is axially sectioned into quarters by perpendicular grooves 36 and 38. To maintain the bearing assemblies 30 on their respective stub shafts, the ends of the stub shafts are formed with radially extending flanges or lips 40. Thus, during assembly, the stub shafts are radially compressed so that the bearings 34 can slide over the lips 40 of the stub shafts. Once the lips 40 clear the back sides of the bearings 34, the stub shafts snap back to their original diameter so that the lips 40 abut the back sides of the bearings 34 to secure the bearing assemblies 30 to the stub shafts 18a, 20a.

The bearing housings 32 are formed with tabs or projections 42a that are received in slots or apertures in the sidewalls of the conveyor frame when the conveyor rollers are installed. The tabs 42a and corresponding slots in the sidewalls of the conveyor frame are configured so that the bearing housings 32 cannot rotate relative to the sidewalls.

Preferably, the cartridge assemblies are made of an electrically conductive material so that static electricity that builds up in the roller tube 16 can be dissipated. The cartridge assemblies 18, 20 may be made of a polymer, and injection molded from a static conductive polypropylene, such as ESDC 100.5 from the RTP Company. Alternatively, the cartridge assemblies may be made of a polymer available from E. I. duPont de Nemours & Co. sold under the trademark Delrin®. For added rigidity, the cartridge assemblies may be die cast from, e.g., zinc.

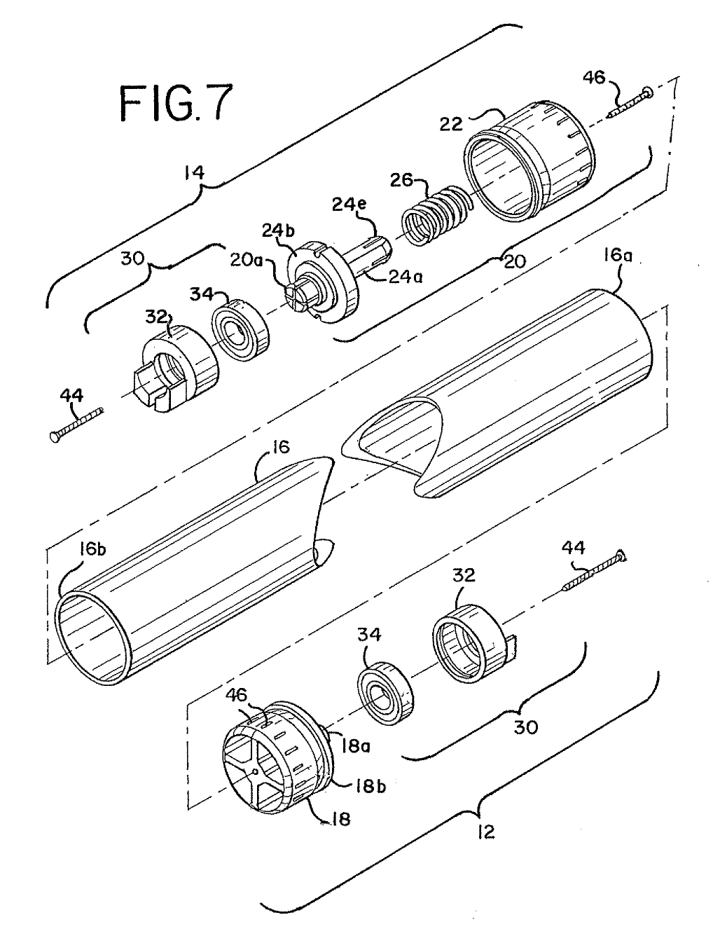

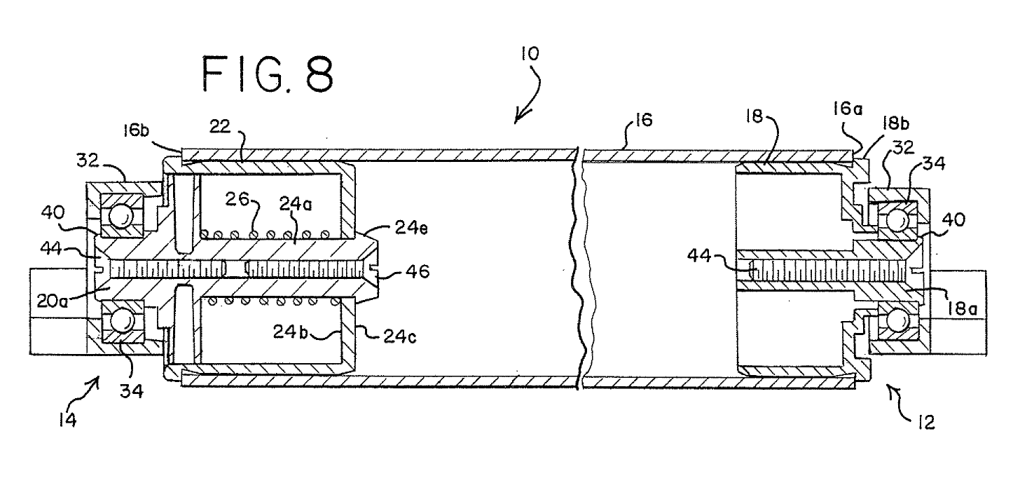

Turning to FIGS. 7 and 8, a second embodiment of a conveyor roller assembly and cartridge bearings in accordance with the preset invention is shown. In this embodiment, each stub shaft includes a central bore that receives an axially-disposed reinforcing pin or screw 44 (a flat head screw being shown) that is installed after the bearings 34 are snapped into place on their respective stub shafts. The pin or screw 44 serves to prevent compression of the stub shafts, and generally adds greater strength to the cartridge.

In addition, the rotor clip 36 seen in FIGS. 1 and 2 has been eliminated from this embodiment. Instead, the bearings 34 are retained in the housings 32 by means of being molded in place. The rotor clip 28 and corresponding groove 24d of the FIG. 1 embodiment have also been eliminated. Instead, the inner end of the axially-moveable stub shaft 24a is axially compressible to an extent to permit it to fit through the aperture in the cup insert 22. To this end, the inner end of the stub shaft 24a is axially sectioned into quarters, as described above with respect to stub shafts 18a, 20a. The inner end of the stub shaft 24a is formed with an enlarged shoulder 24e that acts as a stop to maintain the stub shaft in the insert. A reinforcing pin or screw 46 is received in the central bore of the stub shaft 24a to prevent compression of the inner end after the stub shaft is assembled in the insert.

Also, to help secure the insert 18, 20 against the inner wall of the tubing 5, the inserts are formed with axially extending ribs 46, which accommodate for tolerance fluctuations on the inside diameter of the tubing 16.

Although the invention has been described in terms of certain specific embodiments, such embodiments are for illustrative purposes, and not for limitation, as various modifications will be apparent to one skilled in the art. Instead, the invention is defined by the scope of the claims.

1. A conveyor roller assembly adapted to be received between opposed sidewalls of a conveyor frame comprising:
a) a cylindrical tube having opposed open ends;
b) an insert received in at least one of the open ends of the cylindrical tube including a stub shaft having a free end that extends from the insert beyond the end of the tube when the insert is received in the tube, the stub shaft being rotationally-fixed relative to the insert so as to be rotatable with the cylindrical tube; and
c) a bearing housing secured to each insert, each bearing housing including at least one bearing adapted to receive the stub shaft so as to permit relative rotational movement between the bearing housing and the insert, the bearing housing being adapted to be supported by the sidewall of the conveyor frame so as to prevent relative rotational movement between the bearing housing and the sidewall.

2. The conveyor roller assembly or claim 1 wherein the bearing housing includes at least one projection adapted to be received in a corresponding aperture in the sidewalls of the conveyor frame.

3. The conveyor roller assembly of claim 1 wherein the stub shaft has an annular projection at its free end for securing the bearing housing to the stub shaft.

4. The conveyor roller assembly of claim 1 wherein the stub shaft of at least one of the inserts is axially moveable relative to the insert.

5. The conveyor roller assembly of claim 4 wherein the axially moveable stub shaft is biased outwardly of the cylindrical tube.

6. A cartridge bearing assembly for a conveyor roller tube comprising:
a) an insert adapted to be received in an open end of the tube including a stub shaft having a free end extending from the insert, the stub shaft being rotationally-fixed relative to the insert; and
b) a bearing housing secured to the stub shaft of the insert and including at least one bearing adapted to receive the stub shaft so as to permit relative rotational movement between the bearing housing and the insert.

7. The cartridge bearing assembly of claim 6 wherein the bearing housing includes at least one projection adapted to be received in an aperture in a conveyor side frame.

8. The cartridge bearing assembly of claim 6 wherein the stub shaft has an annular projection at its free end for securing the bearing housing to the stub shaft.

9. The cartridge bearing assembly of claim 6 wherein the stub shaft is axially moveable relative to the insert.

10. The cartridge bearing assembly of claim 9 wherein the stub shaft is biased outwardly from the insert.

11. The cartridge bearing assembly of claim 6 wherein the assembly is constructed of an electrically conductive material.

12. The cartridge bearing assembly of claim 6 wherein the free end of the stub shaft is radially compressible.

13. The cartridge bearing assembly of claim 6 wherein the insert includes a shoulder portion that extends out from the roller tube when the insert is received therein, the shoulder having at least one radially extending groove.

14. The cartridge bearing assembly of claim 6 further comprising a reinforcing member received axially in the stub shaft.

15. The cartridge assembly of claim 6 wherein the insert comprises an outer surface with a plurality of axially-extending raised ribs.
